(19) United States
(12) Patent Application Publication
(10) Pub. No.: US 2009/0295018 A1
(43) Pub. Date: Dec. 3, 2009

(54) OIL-REMOVING JIG AND METHOD FOR MANUFACTURING FORMED BODY USING THE SAME

(75) Inventor: Makoto MURAI, Nagoya-city (JP)

Correspondence Address: OLIFF & BERRIDGE, PLC, P.O. BOX 320850, ALEXANDRIA, VA, 22320-4850, US

(73) Assignee: NGK INSULATORS, LTD., Nagoya-city (JP)

(21) Appl. No.: 12/541,657

(22) Filed: Aug. 14, 2009

Related U.S. Application Data
(63) Continuation of application No. PCT/JP2008/052528, filed on Feb. 15, 2008.

(30) Foreign Application Priority Data
Mar. 20, 2007 (JP) 2007-072675

(51) Int. Cl. B29C 47/00; B28B 11/22

(52) U.S. Cl. 264/177.12; 425/84

(57) ABSTRACT

There is provided an oil-removing jig for removing oil applied on an outer peripheral face of kneaded clay extruded from a kneader to have a cylindrical shape for the purpose of inhibiting drying prior to feeding the kneaded clay into an extrusion-forming apparatus. The jig includes a tabular rubber plate having a through-hole having a diameter 5 to 30 mm smaller than that of the kneaded clay, and two support plate each having a through-hole having a diameter 25 to 95 larger than that of the kneaded clay and 40 to 100 mm larger than that of the through-hole of the aforementioned rubber plate; and the rubber plate is held between the two support plates and fixed in a state that centers of the through-holes coincide with one another.

### TECHNICAL FIELD

The present invention relates to an oil-removing jig used for removing oil applied on an outer peripheral face of cylindrical clay extruded from a kneader for the purpose of inhibiting drying prior to feeding the clay into an extrusion-forming apparatus and to a method for manufacturing a formed body using the jig.

### BACKGROUND ART

A honeycomb-shaped structure (honeycomb structure) is widely used as a carrier for a chemical reaction apparatus such as a carrier for catalyst purifying exhaust gas from various internal combustion engines, a carrier for a deodorant catalyst, a filter for various filtration apparatuses, a heat-exchanger unit, and a carrier for reforming catalyst of a fuel cell, and the like. Generally, such a honeycomb structure can be manufactured by subjecting kneaded clay made of ceramic raw material or the like to extrusion-forming to obtain a formed body having a predetermined honeycomb structure (honeycomb formed body), followed by drying and firing.

Generally, a kneaded clay used for forming such a honeycomb formed body can be obtained by feeding a forming raw material containing a ceramic powder as the main component into a kneader to knead the forming raw material inside a drum of the kneader with a screw with imparting shearing force to the material, and then continuously extruding the material from an opening portion at a tip of the drum to obtain a cylindrical shape.

The kneaded clay obtained as described above is then fed into a cylinder of extrusion-forming apparatus and extrusion-formed into a predetermined honeycomb shape through a die for forming disposed on the end of outlet side of the cylinder. Here, the cylindrical clay extruded from the kneader is sometimes subjected to coating with oil such as kerosene and machine oil (mineral oil) on the outer peripheral face thereof in order to prevent drying caused before the kneaded clay is fed into an extrusion-forming apparatus.

However, when the kneaded clay is fed into the extrusion-forming apparatus in the state that a large amount of oil is applied on the outer peripheral face of the kneaded clay, slippage is caused in a contact portion between the outer peripheral face of the kneaded clay and the inner peripheral face of the cylinder of the extrusion-forming apparatus, and thereby the extrusion speed of the outer peripheral face of the kneaded clay becomes higher than that of the central portion, which causes a problem of deformation in cells in the vicinity of the outer periphery of a honeycomb formed body obtained by extrusion-forming.

In order to cope with such a problem, there has been taken a measure of manually wiping off the oil applied on the outer peripheral face of the kneaded clay (There has been available no prior art document relating to such a conventional technique.). However, since such a manual operation requires much labor and time, it is unsuitable for mass production, and therefore, an easier measure has been desired.

### DISCLOSURE OF THE INVENTION

The present invention has been made in view of such a conventional situation and aims to provide an oil-removing jig capable of easily removing oil applied on an outer peripheral face of kneaded clay having a cylindrical shape extruded from a kneader for the purpose of inhibiting drying prior to feeding the kneaded clay into an extrusion-forming apparatus and a method for manufacturing a formed body using the jig.

In order to achieve the above aim, according to the present invention, there is provided the following oil-removing jig and method for manufacturing a formed body.

[1] An oil-removing jig for removing oil applied on an outer peripheral face of kneaded clay having a cylindrical shape extruded from a kneader for the purpose of inhibiting drying prior to feeding the kneaded clay into an extrusion-forming apparatus, wherein the jig comprises: a tabular rubber plate having a through-hole having a diameter 5 to 30 mm smaller than that of the kneaded clay formed therein, and two support plates each having a through-hole having a diameter 25 to 95 mm larger than that of the kneaded clay and 40 to 100 mm larger than that of the through-hole of the aforementioned rubber plate; the rubber plate being held between the two support plates and fixed in a state that centers of the through-holes coincide with one another.

[2] The jig for removing oil according to [1] wherein the rubber plate has a hardness of 40 to 60°.

[3] The jig for removing oil according to [1] or [2], wherein the rubber plate has a thickness of 2 to 7 mm.

[4] The jig for removing oil according to any one of [1] to [3], wherein the rubber plate is of silicon rubber, urethane rubber, or neoprene rubber.

[5] A method for manufacturing a formed body comprising the steps of: passing the kneaded clay having a cylindrical shape extruded from the kneader and being provided with an oil for inhibiting drying applied on an outer peripheral face thereof through the through-holes of the jig for removing oil according to any one of [1] to [4] to remove the oil applied on the outer peripheral face of the kneaded clay, and feeding the kneaded clay into the extrusion-forming apparatus.

[6] The method for forming a formed body according to [5], wherein the formed body is a honeycomb formed body.

By the use of an oil-removing jig of the present invention, oil applied on an outer peripheral face of kneaded clay having a cylindrical shape extruded from a kneader for the purpose of inhibiting drying can easily be removed prior to feeding the kneaded clay into an extrusion-forming apparatus. In addition, according to a method for manufacturing a formed body of the present invention, after the oil applied on the outer peripheral face of the kneaded clay is removed by using the oil-removing jig, the kneaded clay is fed into an extrusion-forming apparatus, and thereby deformation due to the oil of the formed body can be inhibited easily.

### BRIEF DESCRIPTION OF THE DRAWINGS

FIG. 1A A plan view showing an example of a structure of an oil-removing jig of the present invention.

FIG. 1B An A-A cross-sectional view of FIG. 1A.

FIG. 2 An explanatory view showing an example of usage of an oil-removing jig of the present invention.

FIG. 3 An explanatory view showing an example of usage of an oil-removing jig of the present invention.

### DESCRIPTION OF REFERENCE NUMERALS

1: oil-removing jig, 2: rubber plate, 3: support plate, 4: through-hole, 5: through-hole, 6: frame, 7: bolt, 8: clay

### BEST MODE FOR CARRYING OUT THE INVENTION

Hereinbelow, representative embodiments of the present invention will be described specifically with referring to drawings. However, the present invention is by no means limited to the following embodiments, and it should be understood that changes, improvements, and the like of the design may be made on the basis of ordinary knowledge of a person ordinary skill in the art within the range of not deviating from the gist of the present invention.

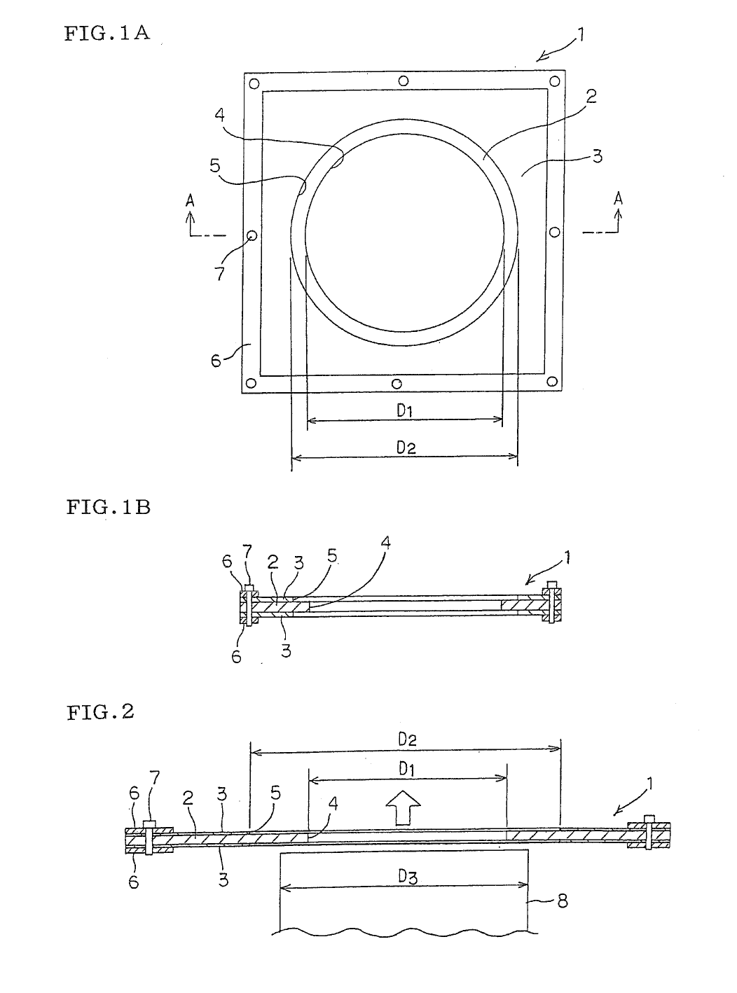

FIGS. 1A and 1B show an example of a structure of an oil-removing jig of the present invention. FIG. 1A is a plan view, and FIG. 1B is an A-A cross-sectional view of FIG. 1A. The oil-removing jig 1 is a jig used for removing oil applied on an outer peripheral face of kneaded clay having a cylindrical shape extruded from a kneader for the purpose of inhibiting drying prior to feeding the clay into an extrusion-forming apparatus.

The oil-removing jig 1 has a tabular rubber plate 2 having a through-hole 4 having a diameter D₁ which is 5 to 30 mm smaller than that of the kneaded clay having a cylindrical shape to be subjected to oil-removing, and two support plates 3 each having a through-hole 5 having a diameter D₂ which is 25 to 95 mm larger than that of the diameter of the kneaded clay and 40 to 100 mm larger than that of the through-hole 4 of the rubber plate 2, and the rubber plate 2 is held between the two support plates 3 and fixed in a state that the centers of the through-holes coincides with one another. In the present embodiment, the support plates 3 and the rubber plate 2 piled up as described above are unitarily fixed by fastening with a bolt 7 by means of a frame 6 in the vicinity of the outer periphery.

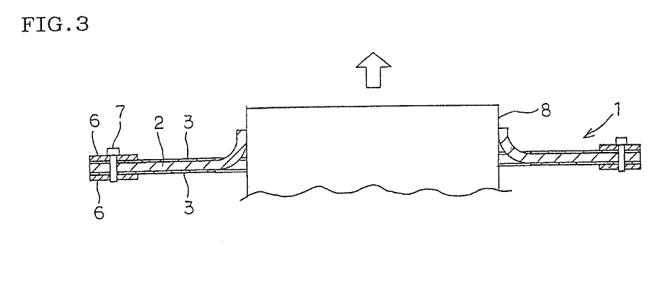

As shown in FIG. 2, when the kneaded clay having a cylindrical shape 8 extruded from a kneader and having oil applied on the outer peripheral face thereof for inhibiting drying is passed through the through-hole of the oil-removing jig 1 having such a structure as described above, the rubber plate 2 having a through-hole 4 having a diameter D₁ smaller than the diameter D₃ of the clay 8 is brought into contact with the outer peripheral face of the clay 8 in a state that a peripheral portion of the through-hole is bent as shown in FIG. 3, and the clay 8 moves in one direction in this state, thereby moderately removing the oil applied on the outer peripheral face by scraping the oil with the rubber plate 2.

Incidentally, it is not necessary to completely remove the oil applied on the outer peripheral face of the clay 8, and a little oil remaining to some extent is preferable because the kneaded clay can be inserted smoothly into the cylinder of the extrusion-forming apparatus. The oil-remaining state can be controlled by the difference between the diameter D₃ of the clay 8 and the diameter D₁ of the through-hole 4 of the rubber plate 2, the difference between the diameter D₃ of the clay 8 and the diameter D₂ of the through-hole 5 of the support plates 3, or the difference between the diameter D₁ of the through-hole 4 of the rubber plate 2 and the diameter D₂ of the through-hole 5 of the support plates 3 and can be adjusted also by the hardness, thickness, or the like of the rubber plate 2.

As described above, in an oil-removing jig of the present invention, the diameter D₁ of the through-hole 4 of the rubber plate 2 is made 5 to 30 mm, preferably 5 to 25 mm, and more preferably 10 to 25 smaller than the diameter D₃ of the kneaded clay 8. When the difference (D₃−D₁) between the diameter D₃ of the clay 8 and the diameter D₁ of the through-hole 4 of the rubber plate 2 is less than 5 mm, the removal of the oil is prone to be insufficient, and superfluous oil remains on the outer peripheral face of the kneaded clay 8. Therefore, deformation of the formed body caused by the remaining oil cannot effectively be suppressed. On the other hand, when the difference between the diameter D₃ of the clay 8 and the diameter D₁ of the through-hole 4 of the rubber plate 2 is more than 30 mm, the clay 8 may have difficulty in passing through the oil-removing jig 1, or oil is excessively removed to cause difficulty in allowing the clay 8 to enter the cylinder of the extrusion forming apparatus.

In addition, in an oil-removing jig of the present invention, the diameter D₂ of the through-hole 5 of the support plates 3 is made 25 to 95 mm, preferably 25 to 85 mm, and more preferably 35 to 85 mm larger than the diameter D₃ of the clay 8 and 40 to 110 mm larger than the diameter of the through-hole 4 of the rubber plate 2. When the difference (D₂−D₃) between the diameter D₂ of the through-hole 5 of the support plates 3 and the diameter D₃ of the kneaded clay 8 is less than 25 mm, or when the difference (D₂−D₃) between the diameter D₂ of the through-hole 5 of the support plates 3 and the diameter D₁of the through-hole 4 of the rubber plate 2 is less than 40 mm, oil is overly removed to cause difficulty in allowing the kneaded clay 8 to enter the cylinder of the extrusion-forming apparatus or to inhibit the rubber plate 2 from bending sufficiently to hinder the kneaded clay 8 from passing through the through-hole in some cases. On the other hand, when the difference between the diameter D₂ of the through-hole 5 of the support plates 3 and the diameter D₃ of the clay 8 is more than 95 mm, or when the difference between the diameter D₂ of the through-hole 5 of the support plates 3 and the diameter D₁ of the through-hole 4 of the rubber plate 2 is more than 110 mm, superfluous oil remains on the outer peripheral face of the kneaded clay 8, and therefore deformation of the formed body caused by the remaining oil cannot effectively be suppressed.

Further, in an oil-removing jig of the present invention, the rubber plate 2 has a hardness of preferably 40 to 60°, and more preferably 45 to 55°. Further, in an oil-removing jig of the present invention, the rubber plate 2 has a thickness of preferably 2 to 7 mm, and more preferably 4 to 6 cm. When the rubber plate 2 has a hardness of less than 40° and a thickness of less than 2 mm, superfluous oil is prone to remain on the outer peripheral face of the kneaded clay, and the effect in suppressing deformation of the formed body caused by the remaining oil tends to decrease. On the other hand, when the rubber plate 2 has a hardness of more than 60° and a thickness of more than 7 mm, the oil is prone to be removed overly, and there is a tendency of having difficulty in allowing the kneaded clay 8 to enter the cylinder of the extrusion-forming apparatus. Incidentally, the “hardness of the rubber plate” referred to in the present specification is a value measured according to JIS K 6253.

A material for the rubber plate 2 preferably has oil resistance where the rubber plate 2 is hardly deteriorated by the contact with the oil applied on the kneaded clay 8. Examples of the suitable material include silicon rubber, urethane rubber, and neoprene rubber.

The support plate 3 may employ any material and thickness unless deformation or damage is caused due to pressure upon passing of the kneaded clay 8. For example, a support plate 3 obtained by forming a through-hole in a stainless-steel plate having a thickness of about 1 to 2 mm can suitably be used.

A method for manufacturing a formed body of the present invention includes the steps of: passing the kneaded clay having a cylindrical shape extruded from the kneader and having the oil for inhibiting drying applied on the outer peripheral face thereof through the through-holes of the jig for removing oil of the present invention described above to remove the oil applied on the outer peripheral face of the kneaded clay, and feeding the kneaded clay into the extrusion-forming apparatus.

As described above, by using an oil-removing jig of the present invention, oil applied on the outer peripheral face of the kneaded clay having a cylindrical shape for inhibiting drying can easily be removed, and, by feeding kneaded clay into the extrusion-forming apparatus after the oil is removed, deformation of the formed body caused by the oil can easily be suppressed.

The shape of the formed body manufactured by a manufacturing method of the present invention is not particularly limited as long as the shape can be obtained by extrusion forming and suitable for manufacturing, for example, a honeycomb formed body which has thin partition walls partitioning cells and is prone to have deformation.

In addition, the kind of the oil for inhibiting drying which is removed by an oil-removing jig of the present invention is not particularly limited, and, as examples of the oil used for this kind of purpose include kerosene and machine oil (mineral oil).

### EXAMPLES

Hereinbelow, the present invention will be described in more detail on the basis of the Examples. However, the present invention is by no means limited to these Examples.

### Examples 1 to 7 and Comparative Examples 1 and 2

As a forming raw material, a mixture of a ceramic powder and methyl cellulose was used. The mixture was fed into a drum of a kneader to be kneaded with a screw, followed by being extruded from an opening at an end of drum as kneaded clay having a cylindrical shape (diameter: 280 mm). Kerosene as oil for inhibiting drying was applied on the entire outer peripheral face of the extruded kneaded-clay above. After 105 hours have passed, the kerosene was removed by an oil-removing jig. The oil-removing jig was obtained by integration by holding a silicon rubber plate (hardness: 50°, thickness: 5 mm) having a through-hole having a diameter of 265 mm between two stainless-steel support plates each having a through-hole having a diameter shown in Table 1. After the kneaded clay was passed through the through-hole of the oil-removing jig to remove the oil, the kneaded clay was inserted into a cylinder (inner diameter: 290 mm) of an extrusion-forming apparatus to obtain a honeycomb formed body (diameter: 200 mm, length: 200 mm, partition wall thickness: 150 μm, cell shape: square, cell density: 64 cells/cm²). The formed body obtained in this manner was examined for the number of cells having any defect (deformation) caused therein to obtain a cell defect incidence. The results are shown in Table 1.

### Comparative Example 3

A kneaded clay having a cylindrical shape was extruded from a kneader, and kerosene was applied on the whole outer peripheral face thereof in the same manner as in Examples 1 to 7 and Comparative Example 1 and 2. Then, without removing the kerosene, the kneaded clay was inserted into an extrusion-forming apparatus to perform extrusion forming in the same manner as in Examples 1 to 7 and Comparative Examples 1 to 2 to obtain a honeycomb formed body. The formed body obtained in this manner was examined for the number of cells having any defect (deformation) caused therein to obtain a cell defect incidence. The results are shown in Table 1.

TABLE 1

| | Diameter | Diameter | Diameter | | | | | | |
|---|---|---|---|---|---|---|---|---|---|
| | (D₃) of | (D₂) of | (D₁) of | | | | | | |
| | kneaded | through-hole | through-hole | | | | Thickness | Hardness of | Cell defect |
| | clay | of support | of rubber | D₃-D₁ | D₂-D₁ | D₂-D₃ | of rubber | rubber plate | incidence* |
| | [mm] | plate [mm] | plate [mm] | [mm] | [mm] | [mm] | plate [mm] | [°] | [%] |
| Comparative | 280 | 295 | 265 | 15 | 30 | 15 | 5 | 50 | Clay not passed |
| Example 1 | | | | | | | | | |
| Example 1 | 280 | 305 | 265 | 15 | 40 | 25 | 5 | 50 | 2 |
| Example 2 | 280 | 315 | 265 | 15 | 50 | 35 | 5 | 50 | 0 |
| Example 3 | 280 | 325 | 265 | 15 | 60 | 45 | 5 | 50 | 0 |
| Example 4 | 280 | 335 | 265 | 15 | 70 | 55 | 5 | 50 | 0 |
| Example 5 | 280 | 345 | 265 | 15 | 80 | 65 | 5 | 50 | 0 |
| Example 6 | 280 | 355 | 265 | 15 | 90 | 75 | 5 | 50 | 0 |
| Example 7 | 280 | 375 | 265 | 15 | 110 | 95 | 5 | 50 | 3 |
| Comparative | 280 | 395 | 265 | 15 | 130 | 115 | 5 | 50 | 7 |
| Example 2 | | | | | | | | | |
| Comparative | 280 | — | — | — | — | — | — | — | 10 |
| Example 3 | | | | | | | | | |

*Cell defect incidence [%] = Number of cells having deformation/Number of the whole cells × 100

As shown in Table 1, in Examples 1 to 7, where the difference (D₃−D₁) between the diameter of the kneaded clay and the diameter of the through-hole of the rubber plate was within the range from 5 to 30 mm, the difference (D₂−D₁) between the diameter of the through-hole of the support plate and the diameter of the through-hole of the rubber plate was within the range from 40 to 110 mm, and the difference (D₂−D₃) between the diameter of the through-hole of the support plate and the diameter of the kneaded clay was within the range from 25 to 95 mm, the deformation was hardly found in the cells of the honeycomb formed bodies. In contrast, in Comparative Example 1, where the difference between the diameter of the through-hole of the support plate and the diameter of the through-hole of the rubber plate was less than 40 mm, and the difference (D₂−D₃) between the diameter of the through-hole of the support plate and the diameter of the clay was less than 25 mm, the kneaded clay could not pass through the through-hole of the oil-removing jig. In addition, in Comparative Example 2, where the difference between the diameter of the through-hole of the support plate and the diameter of the through-hole of the rubber plate was more than 110 mm, and the difference between the diameter of the through-hole of the support plate and the diameter of the kneaded clay was more than 95 mm, and in the Comparative Example 3, where oil was not removed by the oil-removing jig, 7% or more of the cells had defects (deformation).

### INDUSTRIAL APPLICABILITY

The present invention is used in order to remove oil applied on an outer peripheral face of kneaded clay having a cylindrical shape extruded from a kneader for the purpose of inhibiting drying prior to feeding the clay into an extrusion-forming apparatus and can suitably be used for manufacturing a formed body obtained by extrusion forming such as a honeycomb formed body.

1. An oil-removing jig for removing oil applied on an outer peripheral face of kneaded clay having a cylindrical shape extruded from a kneader for the purpose of inhibiting drying prior to feeding the clay into an extrusion-forming apparatus,
wherein the jig comprises: a tabular rubber plate having a through-hole having a diameter 5 to 30 mm smaller than that of the clay, and two support plates each having a through-hole having a diameter 25 to 95 larger than that of the clay and 40 to 100 mm larger than that of the through-hole of the aforementioned rubber plate; the rubber plate being held between the two support plates and fixed in a state that centers of the through-holes coincide with one another.

2. The jig for removing oil according to claim 1 wherein the rubber plate has a hardness of 40 to 60°.

3. The jig for removing oil according to claim 1, wherein the rubber plate has a thickness of 2 to 7 mm.

4. The jig for removing oil according to claim 1, wherein the rubber plate is of silicon rubber, urethane rubber, or neoprene rubber.

5. A method for manufacturing a formed body comprising the steps of: passing the kneaded clay having a cylindrical shape extruded from the kneader and having the oil for inhibiting drying applied on the outer peripheral face thereof through the through-holes of the jig for removing oil according to claim 1 to remove the oil applied on the outer peripheral face of the clay, and feeding the clay into the extrusion-forming apparatus.

6. The method for forming a formed body according to claim 5, wherein the formed body is a honeycomb formed body.

7. The jig for removing oil according to claim 2, wherein the rubber plate has a thickness of 2 to 7 mm.

8. The jig for removing oil according to claim 2, wherein the rubber plate is of silicon rubber, urethane rubber, or neoprene rubber.

9. The jig for removing oil according to claim 3, wherein the rubber plate is of silicon rubber, urethane rubber, or neoprene rubber.

10. A method for manufacturing a formed body comprising the steps of: passing the kneaded clay having a cylindrical shape extruded from the kneader and having the oil for inhibiting drying applied on the outer peripheral face thereof through the through-holes of the jig for removing oil according to claim 2 to remove the oil applied on the outer peripheral face of the clay, and feeding the clay into the extrusion-forming apparatus.

11. A method for manufacturing a formed body comprising the steps of: passing the kneaded clay having a cylindrical shape extruded from the kneader and having the oil for inhibiting drying applied on the outer peripheral face thereof through the through-holes of the jig for removing oil according to claim 3 to remove the oil applied on the outer peripheral face of the clay, and feeding the clay into the extrusion-forming apparatus.

12. A method for manufacturing a formed body comprising the steps of: passing the kneaded clay having a cylindrical shape extruded from the kneader and having the oil for inhibiting drying applied on the outer peripheral face thereof through the through-holes of the jig for removing oil according to claim 4 to remove the oil applied on the outer peripheral face of the clay, and feeding the clay into the extrusion-forming apparatus.

13. The method for forming a formed body according to claim 10, wherein the formed body is a honeycomb formed body.

14. The method for forming a formed body according to claim 11, wherein the formed body is a honeycomb formed body.

15. The method for forming a formed body according to claim 12, wherein the formed body is a honeycomb formed body.
